(19) United States
(12) Patent Application Publication
(10) Pub. No.: US 2002/0057481 A1
(43) Pub. Date: May 16, 2002

(54) Beam scanning type laser marking device

(76) Inventors: Akihiko Souda, Hiratsuka-city (JP); Ryuusuke Komura, Hiratsuka-city (JP); Teiichirou Chiba, Hiratsuka-city (JP)

Correspondence Address: VARNDELL & VARNDELL, PLLC, 106-A S. COLUMBUS ST., ALEXANDRIA, VA, 22314, US

(21) Appl. No.: 09/984,916

(22) Filed: Oct. 31, 2001

(30) Foreign Application Priority Data
Nov. 7, 2000 (JP) 2000-338848

(51) Int. Cl. G02B 26/08

(52) U.S. Cl. 359/205; 359/212

(57) ABSTRACT

A beam scanning type laser marking device suitable for forming minute dot marks which can ensure the visibility is provided. In this beam scanning type laser marking device which performs a marking on a surface to be marked through a convergence lens system by scanning laser beams irradiated from a laser oscillator in a given pattern using a scanning mirror, the convergence lens system is comprised of three or more convergence lenses, a focal length of an fθ lens which is arranged at a position closest to the scanning mirror side is set to a distance which prevents the fθ lens from interfering with a first scanning mirror which is arranged to face the fθ lens in an opposed manner, and the center of the first scanning mirror is arranged to coincide with a front-side focal position of the fθ lens, and the convergence lens system has lenses thereof sequentially arranged in a telecentric relationship. As a result, an offset amount of a formed image can be minimized so that a dot interval which does not give an influence to the visibility even with dot marks of minute configuration can be ensured.

### BACKGROUND OF THE INVENTION

1. Field of the Invention

The present invention relates to a beam scanning type laser marking device which marks a pattern such as characters or the like on a surface to be marked by scanning laser beams excited by pulses.

2. Description of the Related Art

Conventionally, there has been known a beam scanning type laser marking device which marks various kinds of information including a 2D code or given characters which are formed of a group made of a large number of dots on a surface to be marked by condensing and scanning laser beams obtained by a CW excited Q switch pulse oscillation to the surface to be marked using a scanning mirror and a convergence lens system.

FIG. 5 shows a schematic constitution of a general beam scanning type laser marking device which is disclosed in Japanese Laid-open Patent Publication 150484/1996, for example.

A laser oscillator 1 includes an ultrasonic Q switch element 2 and the ultrasonic Q switch element 2 performs a CW excited Q switch pulse oscillation through a driving circuit 3 in synchronism with a Q switch control signal which is a repeated frequency of a RF power transmitted from a control unit 4 and irradiates laser beams. The laser beams irradiated from the laser oscillator 1 are reflected on scanning mirrors 5x, 5y which are mounted on a pair of galvanometers 4x, 4y and are focused on the surface to be marked through a fθ lens 6. The scanning mirrors 5x, 5y are reciprocally rotatably driven about an axis which is perpendicular to a paper surface and about an axis which is parallel to the paper surface and is inclined by 45° C. so as to scan the surface to be marked. A given pattern is marked on the surface to be marked in this manner.

Here, recently, as disclosed in Japanese Laid-open Patent Publication 137744/1992, dot marks which are formed by scanning continuous pulse laser beams are miniaturized compared to a conventional dot mark configuration such that the dot marks have the bore diameter of 30 μm and the depth of 0.5 to 1.5 μm. Most recently, as described in Japanese Laid-open Patent Publication 162800/1999 and Japanese Laid-open Patent Publication 223382/2000, for example, dot marks which have the bore diameter of 1 to 15 μm and the depth of 0.5 to 1.5 μm or extremely miniaturized dot marks which have a peculiar configuration in which dot marks have a skirt diameter of the same numerical value range and have the centers thereof raised and the raised height is 0.01 to 0.5 μm are proposed.

However, in view of the fact that the basic structure of the beam scanning type laser marking device has the above-mentioned constitution and there is no inconvenience in forming dot marks having the large configuration as in the case of the past and hence, it is the current state that no special improvement has been made to the convergence lens system and the scanning structure which performs marking by oscillating pulse laser beams which are focused through a fθ lens in biaxial directions consisting of an x axis and a y axis using a pair of scanning mirrors.

FIG. 3 shows a conventional convergence optical system consisting of a convergence lens system and a scanning structure. The conventional convergence lens system is constituted of a single fθ lens 6 as mentioned above and pulse laser beams which are reflected on a second scanning mirror not shown in the drawing are incident on the fθ lens 6 after being reflected again on a first scanning mirror 5x. Laser beams which have passed through the fθ lens 6 are converged and focused on a marking surface MS thus forming dot marks.

The first scanning mirror 5x is arranged such that a front-side focusing position of the above-mentioned fθ lens 6 is made to coincide with the rotating axis of the first scanning mirror 5x and, at the same time, the center position of the first scanning mirror 5x coincides with an optical axis of the fθ lens 6. Accordingly, when the oscillating angle of the first scanning mirror 5x is set to 0 (rad), a so-called telecentric arrangement relationship is formed, wherein a reflection light of the light incident on the center of the first scanning mirror 5x advances along an optical path which is parallel to the optical axis after passing the fθ lens 6, and an incident light parallel to the light incident on the center of the mirror 5x forms an image on a plane which passes a rear-side focal point and is perpendicular to the optical axis.

A distance h from the optical axis on this image forming surface to an image forming position is given by a following equation and is determined by the oscillating angle θ of the first scanning mirror 5x.

h=fb′×(2θ)

Accordingly, when a slight fluctuation δθ is generated with respect to the oscillating angle θ of the first scanning mirror, the image is offset in the direction perpendicular to the optical axis at the image forming position thus giving rise to a fluctuation of the formed image by an offset amount δh (=fb′×(2δθ)). On the other hand, as shown in FIG. 4, when the arrangement position of the first scanning mirror 5x is offset from the front-side focal position of the fθ lens 6 in the optical axis direction, the image forming position is offset in the front-and-rear direction along the optical axis with respect to the image forming surface so that the telecentric characteristic is collapsed whereby the principal ray is no more perpendicular to the marking surface. This means that when the marking surface is defocused, the dot interval is changed and, as the result, an offset amount from a designed value is increased.

Accordingly, the larger the offset in the optical axis direction from the front-side focal position of the fθ lens 6, the telecentric characteristic is collapsed and, at the same time, the offset amount δh of the image forming position on the image forming surface is increased and hence, the depth of focus becomes small so that the operability of the laser marker at the time of operating the marking is remarkably reduced.

Although the above-mentioned explanation refers to the first scanning mirror 5x which faces the fθ lens 6 in an opposed manner, the similar phenomenon arises with respect to the second scanning mirror 5y which makes the laser beams scan in the y axis direction.

The influence which such an offset phenomenon gives to the formation of dot marks having a relatively large configuration is small. The reason is that the larger the dot configuration, the pitch between the dots becomes large and hence, along with a fact that the driving control by a galvanometer which drives the scanning mirror is performed with relatively high accuracy, the influence of the offset brought about by the machining accuracy of the galvanometer or the positioning accuracy of the galvanometer at the time of installing, for example, can be easily absorbed.

To the contrary, with respect to the previously-mentioned minute dot marks, the pitch between the dots inevitably becomes extremely minute and hence, the formation of the dots directly receives the influence of the above-mentioned offset so that the predetermined pitch is collapsed and it also gives a large influence to the visibility thereafter whereby a further highly accurate control is required with respect to the formation position of the dot marks on the marking surface.

In general, the performance of the galvanometer is determined based on the linearity of the oscillating angle θ of the scanning mirror in response to an instructed voltage and the temperature drift (gain drift). Even with respect to the galvanometer having the high performance, the fluctuation of the linearity brought about by the tolerance or the fluctuation of the oscillating angle θ brought about by the temperature change is unavoidable. For example, even with a currently high-performance galvanometer, the fluctuation δθ of the oscillating angle θ of the scanning mirror which amounts to approximately 30 μrad is generated.

On the other hand, a pair of scanning mirrors which are oscillated in biaxial directions must be installed at the incident side of the fθ lens. Further, to take the beam diameter of laser beams irradiated from the laser oscillator or the size of the scanning mirror and the like into account, at least 30 mm must be ensured as the front-side focal length fb of the fθ lens. In this case, the offset amount δh of the formed image on the image surface screen is given as follows.

δh=30×2×30×10⁻⁶=1.8×10⁻³ mm=1.8 μm

Here, assuming that the minute dot marks having the dot diameter of 5 μm as mentioned previously are formed on a given region of a semiconductor wafer, the offset amount δh (1.8 μm) of the formed image on the image forming surface surprisingly amounts to 36% of the diameter of the dots. Usually, the pitch between the dot marks is set substantially equal to the diameter of the dots. That is, in the case of the above-mentioned offset amount δh (1.8 μm), the pitch between the neighboring dot marks becomes 3.2 μm and when the pitch becomes narrower than this value, the visibility is lost at the time of reading which follows thereafter. When the diameter of the dots become further small, the reading becomes further difficult.

On the other hand, assuming a case in which the diameter of the dots is set to 30 μm which is smaller than the diameter of the dots in general as described in the above-mentioned Japanese Laid-open Patent Publication 137744/1992, the fluctuation of the pitch brought about by the above-mentioned offset amount δh (1.8 μm) of the formed image on the image forming surface amounts to merely 6%. Accordingly, although the diameter of the dots is minute, the visibility is sufficiently ensured.

Accordingly, it is an object of the present invention to provide a beam scanning type laser marking device which is particularly suitable for the formation of extremely minute dot marks, and can absorb the influence brought about by an offset amount of a formed image on an image forming surface derived from an error in mounting a scanning mirror, the tolerance of a driving device of the scanning mirror or the temperature change which are inevitably generated while allowing the presence of such an offset amount.

### SUMMARY OF THE INVENTION

Inventors of the present invention have repeatedly carried out versatile studies and experiments to develop a technique which can achieve the above-mentioned object by avoiding the interference between a rotating scanning mirror and an fθ lens while understanding the limit of performance of the scanning mirror and a driving device of the scanning mirror.

The offset amount δh of a formed image on an image forming surface is proportional to a rear-side focal length fb′ of the fθ lens and a fluctuation amount δθ of an oscillating angle θ of the scanning mirror. Accordingly, to decrease the offset amount δh of the formed image, it is necessary to make the rear-side focal length fb′ of the fθ lens as small as possible and also to make the fluctuation amount δθ of an oscillating angle θ of the scanning mirror further small.

However, as mentioned previously, a further miniaturization has been in progress with respect to this type of laser marking device and hence, a portion of an optical system in which the scanning mirror and the fθ lens are incorporated must be made compact as a matter of course.

The above-mentioned object can be effectively achieved by following first and second aspects of the present invention.

That is, according to the first aspect of the present invention, there is provided a beam scanning type laser marking device which performs a marking on a surface to be marked through a convergence lens system by scanning laser beams irradiated from a laser oscillator in a given pattern using a scanning mirror, wherein the convergence lens system is comprised of three or more convergence lenses, a focal length of an fθ lens which is arranged at a position closest to the scanning mirror side is set to a distance which prevents the fθ lens from interfering with a first scanning mirror which is arranged to face the fθ lens in an opposed manner, and the center of the first scanning mirror is arranged to coincide with a front-side focal position of the fθ lens, and the convergence lens system has convergence lenses thereof arranged sequentially in a telecentric relationship.

Laser beams irradiated from the laser oscillator are reflected on an optical axis adjusting mirror, for example, and the diameter of the laser beams is expanded by a beam expander. Then, the laser beams become parallel beams and are reflected on a second scanning mirror and a first scanning mirror. Subsequently, the laser beams are incident on the convergence lens system which arranges three or more fθ lenses in an afocal system as parallel beams. The parallel beams which are reflected on the first scanning mirror are incident on the convergence lens system and are firstly focused by a first fθ lens which is arranged to face the first scanning mirror in an opposed manner, and thereafter, a first intermediate image is formed in the vicinity of a rear-side focal position of the first fθ lens.

In this case, to prevent the interference of the above-mentioned first fθ lens with the first scan mirror, the front-side focal length of the first fθ lens is set to a distance of necessity minimum. Accordingly, an offset amount of the image forming position generated by the first fθ lens takes a value of some magnitude which is obtained by the previously-mentioned equation. The laser beams irradiated from this first intermediate image are incident on the second fθ lens and thereafter are irradiated as parallel beams, and an optical flux made of the parallel beams which are incident on the third fθ lens are focused in the vicinity of the rear-side focal position by the third fθ lens so as to form a second intermediate image. Here, by setting the focal length of the third fθ lens to a small value, the second intermediate image is reduced to be smaller than the first intermediate image and an offset amount of the image forming position is made smaller than an offset amount of the first intermediate image.

Here, when the offset amount δh2 of the second intermediate image is a value which does not spoil the visibility of the dot marks which are set to a given final minute size, the marking is performed by directly forming the second intermediate image on a marking surface. However, when the diameter of the dots in the dot mark is extremely small, that is, equal to or less than 5 μm, the visibility is spoiled even when the offset amount δh2 of the second intermediate image is ensured. In this case, the fourth and fifth fθ lenses are further arranged in the above-mentioned convergence lens system.

A plurality of fθ lenses which are arranged in the order of the first fθ lens-the fifth fθ lens-the nth fθ lens are required to constitute an afocal system in which these fθ lenses are arranged to sequentially make the front-side focal position and the rear-side focal position of the neighboring fθ lenses coincide with each other and, at the same time, satisfy the telecentric relationship.

The second aspect of the present invention is characterized in that, in addition to the first aspect of the present invention, two pieces of fθ lenses are arranged in an afocal system on the same optical path between the first scanning mirror and a second scanning mirror which is arranged in a spaced-apart manner from the first scanning mirror with a given distance.

The first scanning mirror is arranged with an inclination angle of 45° C. with respect to the optical axis of the convergence lens system which is arranged to face the first scanning mirror. The first scanning mirror is, for example, reciprocally rotated in the x axis direction about the rotating axis thereof. Further, the second scanning mirror is arranged in parallel to the first scanning mirror with a reflection surface thereof opposed to the first scanning mirror at the laser beam incident side of the first scanning mirror. The second mirror is, for example, reciprocally rotated in the y axis direction about the rotating axis which is parallel to the optical axis of the convergence lens system. Accordingly, it is necessary to arrange these first and second scanning mirrors in a spaced-apart manner. This implies that there is no other way but to provide the unnecessary spaced distance between the second scanning mirror and the first fθ lens of the convergence lens system. As the result, when the marking surface is defocused, the offset amount of the dot interval is increased.

The present invention is provided for accurately forming the dot marks by suppressing the offset of the dot interval derived from such a defocusing of the marking surface. That is, two pieces of fθ lenses are arranged in an afocal system on the same optical axis between the first scanning mirror and the second scanning mirror. In this manner, by arranging two fθ lenses, the laser beams which constitute the optical flux made of parallel beams and are incident on the second scanning mirror directly pass through the fθ lens which is arranged at the second scanning mirror side as parallel beams, and expanded beams which are irradiated from the front-side focal point are incident on the fθ lens which is arranged at the first scanning mirror side.

These incident beams pass through the fθ lens and are incident on the first scanning mirror as the parallel beams again. Then, the incident beams are reflected on the first scanning mirror and are incident on the first fθ lens of the convergence lens system which is arranged in a telecentric manner. Because of the incident laser beams which are incident in this manner, the optical spaced distance between the first and second scanning mirrors can be reduced and, coupled with the above-mentioned convergence lens system of the first aspect of the present invention, an image on the final marking surface with the least offset amount δh from the image forming point can be made.

### BRIEF DESCRIPTION OF THE DRAWINGS

FIG. 1 is an explanatory view showing a schematic constitution of a convergence optical system indicating a typical first embodiment in a beam scanning type laser marking device according to the present invention and a function thereof.

FIG. 2 is an explanatory view showing a schematic constitution of a convergence optical system indicating a second embodiment in the beam scanning type laser marking device according to the present invention and a function thereof.

FIG. 3 is a functional explanatory view showing a schematic constitution of a conventional convergence optical system and an influence brought about by an oscillating angle of a first scanning mirror.

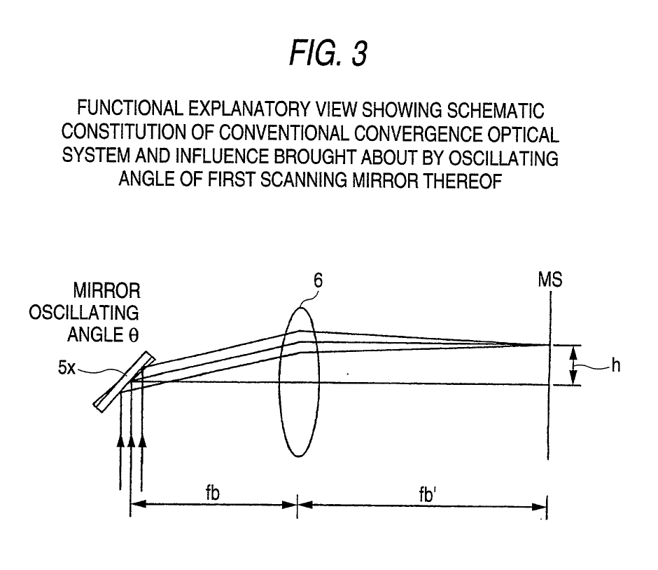

FIG. 4 is a functional explanatory view showing an influence brought about by an offset of an arrangement of a first scanning mirror of a conventional convergence optical system.

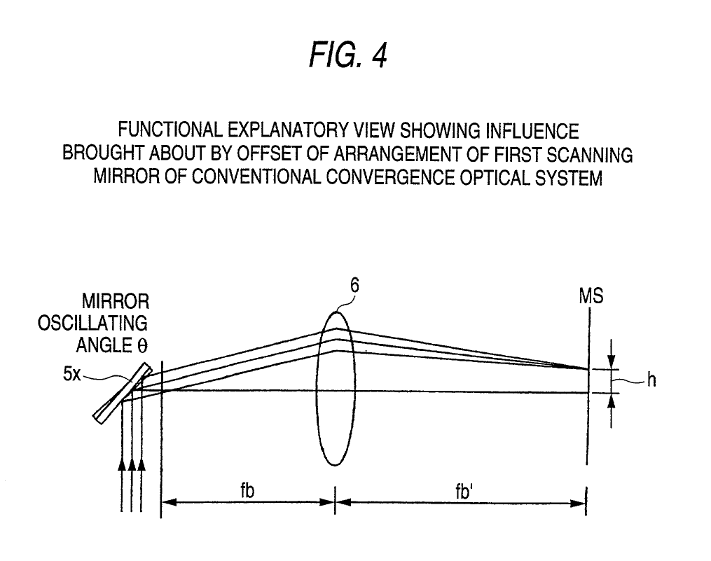

FIG. 5 is an explanatory view showing a general schematic constitution of a beam scanning type laser marking device.

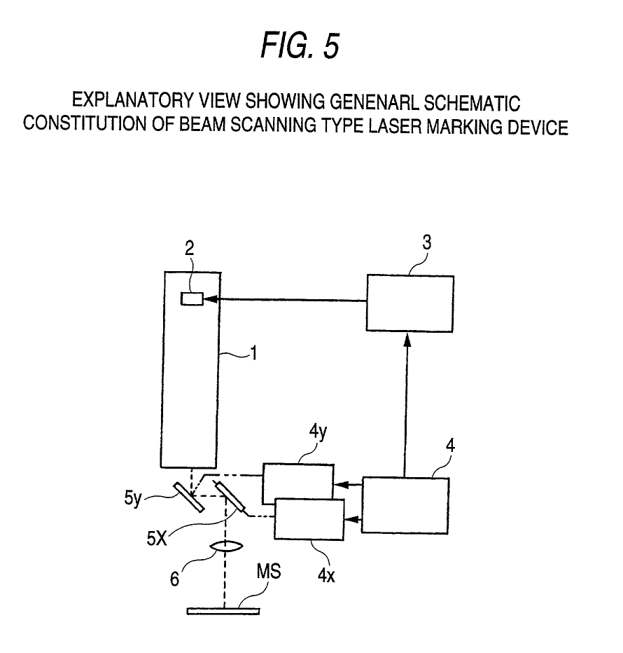

### DETAILED DESCRIPTION OF THE PREFERRED EMBODIMENTS

Preferred embodiments of the present invention are explained specifically in conjunction with attached drawings hereinafter.

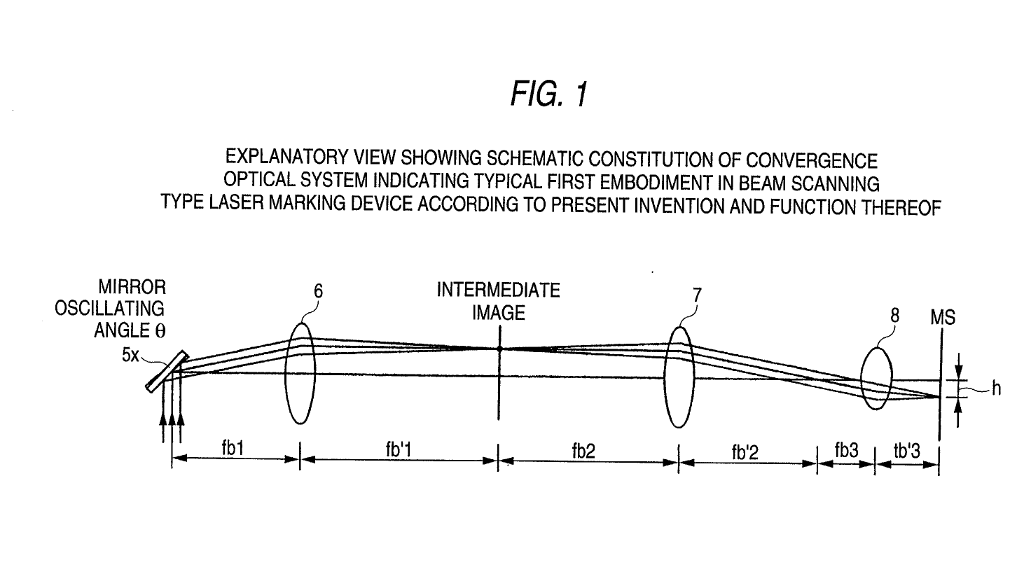

FIG. 1 shows a typical image forming mechanism which is comprised of a first scanning mirror and a convergence lens system according to the first embodiment of the present invention. In the present invention, the number of fθ lenses arranged in the convergence lens system may be three or more depending on the reduction ratio. Further, in the drawing, a second scanning mirror which is arranged at an object side such that the second scanning mirror faces the first scanning mirror is omitted from the drawing.

In the drawing, at an image forming side of the first scanning mirror 5x, the first to third fθ lenses 6 to 8 are arranged on an optical axis thereof. Here, the first scanning mirror 5x is arranged with an inclination angle of approximately 45° C. with respect to the optical axis and is reciprocally rotated in the tilting direction (X axis direction) about a crossing line by a galvanometer not shown in the drawing. The crossing line of the first scanning mirror 5x coincides with a front-side focal position fbl of the first fθ lens 6.

The first to third fθ lenses 6 to 8 constitute the convergence lens system according to the present invention. In the convergence lens system, a rear-side focal position fb′1 of the first fθ lens 6 coincides with a front-side focal position fb2 of the second fθ lens 7 and a rear-side focal position fb′2 of the second fθ lens 7 further coincides with a front-side focal position fb3 of the third fθ lens 8 whereby the convergence lens system is arranged in an afocal system and in a telecentric relationship asawhole. A marking surface MS which constitutes an image forming surface coincides with a rear-side focal position fb′3 of the third fθ lens 8.

Although the first and second fθ lenses 6, 7 have the same focal length and the focal length of the third fθ lens 8 is set shorter than the focal length of the first and second fθ lenses 6, 7, it is not always necessary to make the first and second fθ lenses 6, 7 have the same focal length. However, in any case, it is necessary to constitute the convergence lens system among the first to third fθ lenses 6 to 8.

Here, pulse laser beams which are irradiated from a laser beam oscillator not shown in the drawing pass through an optical axis adjustment mirror and a beam expander not shown in the drawing, are reflected on a second scanning mirror which is driven and controlled by a second galvanometer not shown in the drawing, and are incident on the first scanning mirror 5x. The laser beams incident on the first scanning mirror 5x are reflected on the first scanning mirror 5x and are incident on the first fθ lens 6. Then, the principal ray of the laser beams pass through a front-side focal point of the first fθ lens 6 and are incident on the first fθ lens 6 and then advance as beams parallel to the optical axis, while the laser beams which are incident on other portion of the first fθ lens 6 form an image (an intermediate image Al) in the vicinity of the rear-side focal position fb′1 of the first fθ lens 6 and are incident on the second fθ lens 7 from the image forming point.

An offset amount δh1 from the optical axis of the intermediate image A1 is given by fb′1×2δθ and hence is determined based on the positional accuracy of the mounting position of the first scanning mirror 5x, the tolerance of the galvanometer or the like. Further, since the intermediate image A1 is formed in the vicinity of the front-side focal position fb2 of the second fθ lens 7, the optical flux which passes through the lens 7 becomes parallel beams which are incident on the third fθ lens 8. Since the second and third fθ lenses 7, 8 are arranged in an afocal system, the optical flux which is incident on the third fθ lens 8 forms a final image A2 on a marking surface.

The offset amount δh2 from the image forming position of the final image A2 to the optical axis is given by (fb′3/fb2)×fb′1×2δθ and becomes (fb′3/fb2) of the offset amount δh1 of the intermediate image A1. Here, since the relationship between the focal positions fb′3 and fb2 is set to fb′3<fb2, this implies that the offset amount δh1of the intermediate image A1 is reduced by fb′3/fb2 eventually.

As described above, according to this embodiment, since the convergence lens system which is arranged to face the first scanning mirror 5x in an opposed manner is arranged in the above-mentioned manner, the laser beams pass through the convergence lens system after forming the intermediate image in the midst of the optical axis so as to eventually make the offset amount δh with respect to the optical axis at the image forming position small. Accordingly, even when there exit limits with respect to the characteristics of the galvanometer, the scanning mirror and the like, the influence derived from tolerances thereof can be decreased so that dot marks having a desired minute size can be accurately formed on a desired marking surface.

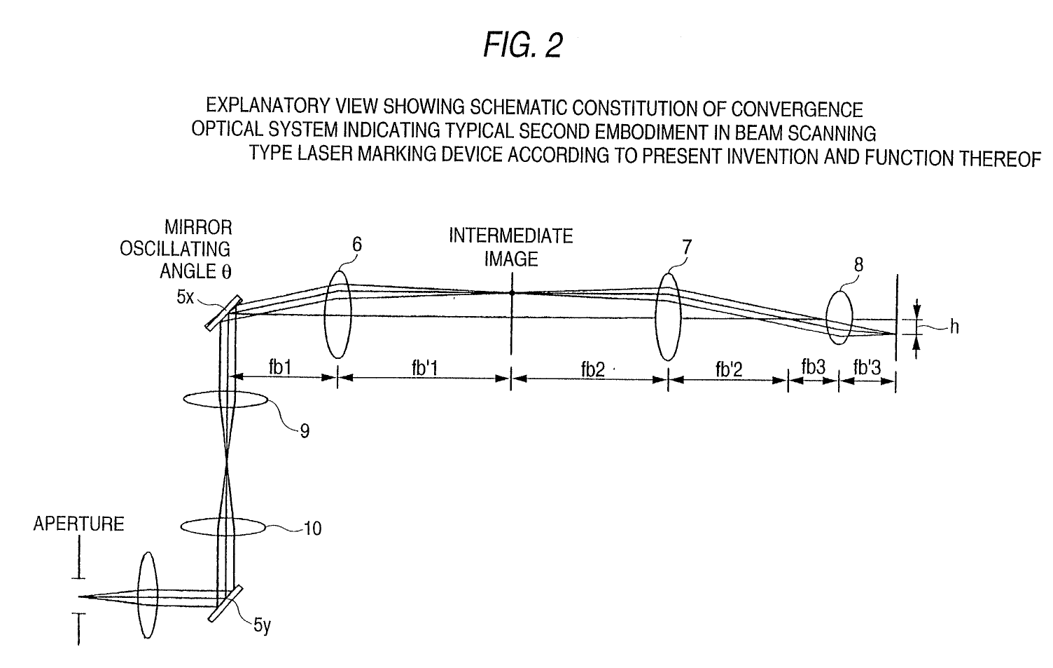

FIG. 2 shows the second embodiment of the present invention. This embodiment is provided for minimizing a defocusing which is generated between a second scanning mirror 5y arranged remote from the above-mentioned convergence lens system and the fθ lens 6 at the scanning mirror side. That is, a reflection light from the second scanning mirror 5y which is reciprocally rotated in the y axis direction is incident on the fθ lens 6 which is disposed closest to the scanning mirror side of the convergence lens system through the first scanning mirror 5x which is reciprocally rotated in the x axis direction with a phase difference of 90° C. Accordingly, the remoter the spaced distance between the arranged position of the fθ lens 6 and the arranged position of the second scanning mirror 5y, the reciprocally rotating positions of the first and/or second scanning mirrors 5x, 5y is liable to be largely offset from the front-side focal length of the fθ lens 6 whereby the offset of the telecentric optical system of the fθ lens 6 is also increased. Further, the oscillating angles θ1, θ2 of the first and/or second scanning mirrors 5x, 5y are expanded.

Accordingly, in this embodiment, by arranging two pieces of fθ lenses 9, 10 in an afocal system on an optical path between the first scanning mirror 5x and the second scanning mirror 5y as shown in FIG. 2, the influence brought about at the time of defocusing and the collapse of the telecentric characteristic can be reduced whereby the positional offset of the formed image on the marking surface can be minimized.

As can be understood from the foregoing explanation, according to the beam scanning type laser marking device of the present invention, in the convergence lens system, the focal length of the fθ lens which is arranged closest to the scanning mirror side is set to the distance which can avoid the interference between the fθ lens and the first scanning mirror which is arranged to face the incident side of the laser beams, and at the same time, the convergence lens system is arranged in an afocal system which ensures the telecentric characteristic among a plurality of fθ lenses with each other and hence, while taking the tolerance of the oscillating angles of the first and second scanning mirrors at the time of driving into consideration, the intermediate image which is formed with a usual offset amount is firstly formed by the first fθ lens, and subsequently, the intermediate image passes through the second fθ lens and the image which is reduced by the third fθ lens which is a reducing lens having a small focal length is formed on the marking surface.

As a result, the offset amount of the formed image with respect to the position where the image is firstly formed by the first fθ lens can be also decreased so that the dot marks which receive the least influence of the offset amount can be formed. Particularly, even with respect to the dot marks which have the minute dot configuration, the influence to the pitch between the dot marks can be minimized so that the visibility of the succeeding steps can be sufficiently ensured.

Further, by arranging two pieces of fθ lenses between both mirrors in an afocal system, even with respect to the offset of the arrangement of the first and second scanning mirrors and the offset of the oscillating angle, the offset amount can be minimized so that the telecentric characteristic can be ensured whereby the positional offset of the formed image can be further reduced.

The above explains the typical embodiments of the present invention and it should be appreciated that, according to the present invention, versatile modifications are conceivable within a scope of claims as has been described above.

1. A beam scanning type laser marking device which performs a marking on a surface to be marked through a convergence lens system by scanning laser beams irradiated from a laser oscillator in a given pattern using a scanning mirror, wherein
the convergence lens system is comprised of three or more convergence lenses,
a focal length of an fθ lens which is arranged at a position close to the scanning mirror side is set to a distance which prevents the fθ lens from interfering with a first scanning mirror which is arranged to face the fθ lens in an opposed manner, and the center of the first scanning mirror is arranged to coincide with a front-side focal position of the fθ lens, and
the convergence lens system has lenses thereof sequentially arranged in a telecentric relationship.

2. A beam scanning type laser marking device according to claim 1, wherein two pieces of fθ lenses are arranged in an afocal system on the optical path between the first scanning mirror and a second scanning mirror which is spaced apart from the first scanning mirror with a given distance.
